(19) United States
(12) Patent Application Publication
(10) Pub. No.: US 2006/0284433 A1
(43) Pub. Date: Dec. 21, 2006

(54) Hoist ring

(76) Inventor: Shu Lan Ma, Industry, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/155,530

(22) Filed: Jun. 17, 2005

(51) Int. Cl. B66C 1/66

(52) U.S. Cl. 294/1.1

(57) ABSTRACT

An improved hoist ring for lifting of equipment or heavy loads adapted for engagement thereto. The device features an attachment end which allows for serpentine three point engagement of the hoist ring to a tether such as a looped lift cable or rope. The engagement eliminates the need to thread the tether through an eye or disconnect the two downward leads of the tether from each other or the lift. Shoulders formed from the lower surface of a “T” shaped engagement member also prevent the lifting cable from sliding off the ends.

### FIELD OF THE INVENTION

The disclosed device relates hoist rings. More particularly it relates to a hoist ring that is typically used to lift very heavy equipment by cooperative engagement of the hoist ring to the equipment being lifted. In conventional use, such devices have a body portion that is threaded or otherwise co-operatively engaged with the equipment being lifted using a bolt through a center aperture in the body portion. The body portion is cooperatively with a closed ring member which engages protruding flanges which are threaded into the sides of the body portion.

Engagement of the ring member to a lifting device such as a hoist or crane is usually accomplished by securing a cable or rope through the eye of the ring member which can be very time consuming especially when multiple pieces of equipment or freight are being lifted and must be engaged and then disengaged from the lift cable. The device herein replaces the conventional closed eye ring member with a “T” shaped ring member which is easily engaged and disengaged from a rope or cable without necessitating threading the cable or rope though and an eye during engagement and disengagement of the lift cable.

### BACKGROUND OF THE INVENTION

In the heavy equipment industry, and shipping of large machinery, there is a constant requirement to relocate equipment which weighs many tons. While such equipment while being large and heavy, most such equipment performs complex physical tasks that require complex and highly accurate movement by the equipment. Consequently, the act of moving such machinery is frequently a delicate maneuver due to the need to protect the equipment from jarring, dropping, and other pitfalls that could ruin its ability to function. For example laths, mills, tape mills, drilling equipment, and other such equipment must operate to manufacture products that have extremely small tolerances when in operation. However, the weight and bulk of this type of heavy equipment naturally make it hard to handle.

As a consequence of both the need to move and relocate heavy equipment, and to protect it from dropping during such movements, manufacturers and owners of such bulky and heavy machinery frequently provide lift points in that equipment to facilitate its transport. Such lift points provide a cooperative means of engagement of the body of the machine or load being hoisted and to a cooperating fastener engaged through an interface device between the crane and lift cable and the machine. Such a cooperative engagement to the machine itself, provides a much better way to hoist it on a crane than simply wrapping netting or cable around the machine itself.

Known as shackles, hoist rings, lifting eyes, and similar names, the interface devices generally follow the same use pattern and feature some sort of U-shaped ring attached at both ends to a centrally located body portion of the hoist ring. The body portion generally swivels in its engagement to the U-shaped ring, and provides a means to self level the equipment being lifted. Generally, the distal ends of this U-shaped ring are engaged with the sides of a body portion of the hoist ring, to provide the favored swivel to the ring.

A problem with this conventional arrangement occurs from the constant need to run the cable or rope used to lift the hoist ring and engaged machine, through the closed eye formed by the “U” shaped ring engaged to the hoist ring body. Generally the cable or rope must be threaded through this eye and then engaged with an upper portion of the cable. Removal of the cable or rope from the eye is in reverse of the engagement. The constant need to thread the cable or rope through the eye for engagement, and back out of the eye for disengagement, can be tedious and time consuming thereby complicating the delicate and dangerous job of hoisting and moving extremely heavy equipment.

U.S. Pat. No. 5,248,176 (Fredriksson) teaches a swivel coupling device for lifting machinery. However, Fredriksson in most embodiments continues teaching the use of a closed ring engaged to the body. In one embodiment a hook replaces the eye, however the hook offers only one contact point for the cable rendering it less stable.

U.S. Pat. No. 2,812,971 (Teutsch) discloses a rotatable hook engaged with a body portion. However, Teutsch places the hook such that it must be removed to engage the hoist to the machine to be lifted, and the hook only offers one point of contact to a cable or rope lessening stability.

U.S. Pat. No. 3,656,797 (Ratcliff) discloses a hook rotatably engaged with a body potion of the hoist ring. However Ratcliff severely limits the lifting capacity of the hoist ring with this engagement and offers only one frictional engagement for the cable. It is really designed for the hook to engage a ring.

As such, there is a continuing need for an improved hoist ring device that will facilitate the easy engagement and disengagement of a looped or loose rope or cable with the device by eliminating the need to thread and unthread the eye component. Such a device should provide a construction maximizing the lift capability of the hoist ring. Further, such a device should provide for a stable engagement of the cable or rope to the top of the hoist ring to minimize tipping and the potential for the hoist ring to fall off the cable or rope should tension be interrupted.

The device herein described and disclosed solves the tedious connection problem of the cable or rope to the body portion of the hoist ring by eliminating the eye from the member engaging the body portion of the hoist ring. The “U” shaped ring conventionally employed is replaced with a generally “T” shaped member engaging a central portion of a smaller ring member with a central shaft of the “T” shaped member. The smaller ring member is in swivelled or rotatable engagement to the side of the body portion of the hoist ring thereby maximizing lifting ability before failure.

Cooperative engagement of this improved hoist ring to the equipment being moved is handled in the conventional fashion by engagement of a threaded bolt through the body portion of the hoist ring, and into cooperating threads in the equipment. However, engagement to the rope or cable descending from the hoist or crane to the hoist ring is significantly improved by the provision of a curved underside to the opposing top members which are engaged to the top end of the central member.

Instead of threading the rope or cable through a closed eye in the tedious aforementioned fashion, the rope or cable may be wound around the two top members whereafter gravity and the weight of the machine being lifted will cause the rope or cable to tightly grip and hold the hoist ring during lifting. Additional engagement of the rope or cable around the hoist ring has been found during experimentation to be provided by an arched or curved lower sidewall of both top members forming the “T” shaped engagement point. The employment of this curved lower surface provides points on the distal ends of both top members which help keep the rope or cable from slipping off. This tight frictional engagement at two points on the horizontally disposed top member thereby providing increased stability. The heavier the machine being lifted, the tighter the friction of the wound cable around the “T” shaped member. Release of the cable or rope from this improved hoist ring is accomplished by simply slackening the cable or rope when the machine is placed on a solid surface and then unwinding it from the “T” shaped member.

Accordingly, it is the object of this invention claimed herein to provide a hoist ring device that eliminates the need to thread cables or ropes through a closed eye for engagement or disengagement.

It is another object of this invention to provide a hoist ring that provides for frictional engagement of the lifting cable or rope at two underside points and one top point of contact to maximize stability and engagement of the hoist ring to the lifting cable or rope.

It is still another object of this invention to provide such a hoist ring that allows easy access to the bolt or other means of cooperative engagement to the machine, without disassembling the hoist ring.

It is an additional object of this invention to provide a hoist ring that allows for a swivelled engagement of the body portion to the cable engaging portion in a fashion that maximizes load lifting capability.

It is yet another object of this invention to provide such a hoist ring which additionally has a shape that prevents the frictionally engaged rope or lifting cable from sliding off.

With respect to the above description, before explaining at least one preferred embodiment of the invention in detail, it is to be understood that the invention is not limited in its application to the details of construction and to the arrangement of the components or steps set forth in the following description or illustrated in the drawings, nor just to buildings. The apparatus of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present disclosed device. It is important, therefore, that the objects and claims be regarded as including such equivalent construction and methodology insofar as they do not depart from the spirit and scope of the present invention. Further objectives of this invention will be brought out in the following part of the specification, wherein detailed description is for the purpose of fully disclosing the invention without placing limitations thereon.

### BRIEF DESCRIPTION OF THE DRAWING FIGURES

The accompanying drawings which are incorporated in and form a part of this specification, illustrate embodiments of the disclosed processing system and together with the description, serve to explain the principles of the invention.

FIG. 1 depicts the hoist ring device showing the “T” shaped cable engagement member terminating with a “U” shaped engagement to a body portion of the device.

FIG. 2 shows a cut away view of the engagement of the body portion to the “T” shaped member.

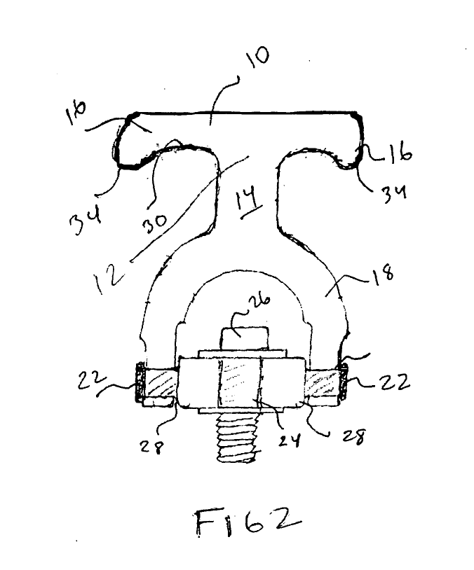

### DETAILED DESCRIPTION OF PREFERRED EMBODIMENTS OF THE DISCLOSED DEVICE

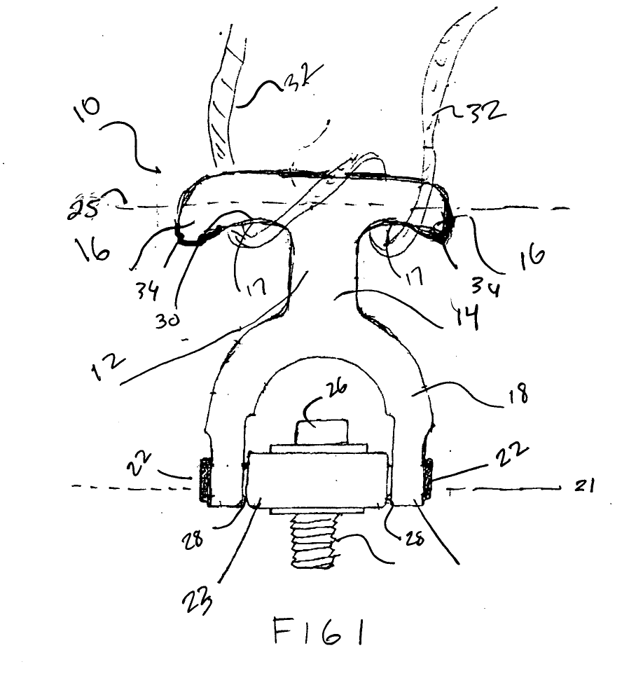

FIG. 1 depicts the disclosed device 10 assembled and ready for engagement to machinery or another load to be lifted. The device 10 features two main components. An engagement member 12 preferably of unitary construction by forging or stamping, has a generally “T” shaped distal or first end and a generally “U” shaped attachment end. The engagement member 12 is formed of a central member 14 which is attached to a pair of support members 16 which extend from the upper or distal end of the end of the central member 12 opposite an engagement end with the central member 12. The engagement end of the central member 14 is engaged at a central point of a substantially “U” shaped ring member 18.

The ring member 18 has two ends each having an aperture 20 communicating therethrough. The apertures 20 are sized for rotational engagement with the exterior of bolts 22 therethrough. The bolts are adapted for cooperative engagement into the sides of a body 23 which is thereby rotationally engaged between the two ends of the ring member 18. The body 23 is adapted for cooperative engagement to a piece of machinery or other load to be lifted through the provision of a body aperture 24 which communicates through a central portion of the body 23 thereby providing communication channel for screw 26 to be engaged to a cooperating aperture in the machinery or load to be lifted by the device 10.

In the preferred mode of the device 10 two shoulders 28 are formed about the perimeter of the body 23 in line along a first axis 21 which runs through the center point of both apertures 20. A bearing surface is machined or otherwise formed about the exterior circumference of the shoulders 28 and mating interior surface of the ends of the ring member 18. These bearing surfaces provide a race or bearing on which the body 23 will easily rotate in engagement with the ring member 18 ends.

Also in a preferred mode of the device 10 the support members 16 extending from the central member 14 have a second axis 25 running through both support members 16 which is substantially parallel to the first axis 21 with both support members 16 substantially inline with each other. The support members 16 are adapted to prevent a rope 32 or cable or other lifting device from slipping off during use. This means for preventing the rope from slipping from the distal ends of the support members 16 is especially desirable in case the device 10 happens to tilt and taking the first and second axis 25 off level.

As shown, a pair of shoulders 34 are formed on the bottom surface at the distal ends of both support members 16. This can be done by placing projections on the bottom surfaces of the support members 16 adjacent to the distal ends. Such projections can be placed on substantially straight bottom surfaces 30 and work well and while not shown, such is anticipated. Or in another particularly preferred mode of the device 10, the shoulders 34 may be provided by forming a curve 17 or arch in bottom surface 30 of the support members 16 such that a projection or shoulder 34 is formed at their respective distal ends which projects past the bottom surface 30 on both distal ends of the respective support members 16. The shoulders 34 have been found through experimentation to help greatly in preventing the flexible tether such as a rope 32 or cable used to engage the device, from slipping from its serpentine tensional engagement around both support members 16 and over the top of the pair of support members 16.

Further, the provision of the “T” shaped engagement member 12 providing a means for three points of force for the engagement for the rope 32 with one on each bottom surface 30 of each support member 16 to bear the weight of the load, and one point of engagement of the rope over the top of the engagement member substantially equidistant between the two bottom points of engagement. This three point engagement of the rope 32 or cable provides an especially stable mount when the rope 30 frictionally engaged in a serpentine wrapping around the support members 17 of the engagement member 12. Using the curved configuration of the bottom surfaces 30 of the support members 30 also allows for two of the three points for the tether 32 to be particularly well supported from sliding.

When the tether or rope is kept equally taught around both support members 16 it helps keep the load lifted level. Further, if the two strands of the tether 32 used for lifting are independently adjustable for length, the provision of the two points of engagement on the bottom surface of the support members 16 provides a means to tip the load by slightly adjusting the length of either strand of the tether 32. This engagement also as noted, makes the device especially easy to engage and disengage with a looped tether 32 when using a rope or cable that is already engaged a lifting device. It eliminates the conventionally employed time consuming operation of threading the distal end of an unhooked cable through an eye and then attaching the loose end of the cable to itself.

Although the invention has been described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention. Any and all such changes, alternations and modifications, as would occur to those skilled in the art, are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. An improved hoist ring for engagement of a looped tether: comprising:
a generally U shaped ring member having a center portion and having two substantially parallel legs terminating at two distal ends;
a pair of apertures communicating through said ring member from an interior side of each of said parallel legs to an exterior side of each of said parallel legs, said apertures located adjacent to both distal ends of said ring member, said apertures each having center points each substantially in line with the other;
a first axis running through said center points;
a body member, rotationally engaged with said pair of apertures;
said body member adapted for engagement to a load to be lifted by said hoist ring;
a central member extending from a connection end at said center portion of said ring member at an angle substantially normal to said first axis, to a distal end;
a pair of support members extending in opposite directions from said distal end of said central member, said support members having an upper surface extending across both said support members, and having a lower surface extending from said central member to respective distal ends of said support members; and
said support members providing means to engage a said tether by serpentine wrapping of said tether around said support members.

2. The hoist ring of claim 1 additionally comprising:
said support members providing said means to engage said tether in said serpentine wrapping in a three point engagement;
a first point being on said lower surface of one of said support members;
a second point being on said lower surface on the other of said support members; and
a third point being on said upper surface.

3. The hoist ring of claim 1 additionally comprising:
means to prevent said tether from sliding off said distal ends of said support members.

4. The hoist ring of claim 2 additionally comprising:
means to prevent said tether from sliding off said distal ends of said support members.

5. The hoist ring of claim 3 wherein said means to prevent said tether from sliding off said distal ends of said support members comprises:
a pair of shoulders, one each of said pair of shoulders being on said lower surface of said support members adjacent to said distal ends of said support members.

6. The hoist ring of claim 3 wherein said means to prevent said tether from sliding off said distal ends of said support members comprises:
said lower surface of each of said pair of support members being curved from an engagement point with said central member to said respective distal ends of said support members; and
center portions of each of said lower surfaces of each of said support members, said center portions being closer to said upper surface than said lower surface at said respective distal ends.

7. The hoist ring of claim 4 wherein said means to prevent said tether from sliding off said distal ends of said support members comprises:
a pair of shoulders, one each of said pair of shoulders being on said lower surface of said support members adjacent to said distal ends of said support members.

8. The hoist ring of claim 4 wherein said means to prevent said tether from sliding off said distal ends of said support members comprises:
said lower surface of each of said pair of support members being curved from an engagement point with said central member to said respective distal ends of said support members; and
center portions of each of said lower surfaces of each of said support members, said center portions being closer to said upper surface than said lower surface at said respective distal ends.

9. The hoist ring of claim 3 wherein said means to prevent said tether from sliding off said distal ends of said support members comprises:
a second axis running through both said first support member and said second support member, said second axis being substantially parallel to said first axis; and
said lower surface of said support members adjacent to said distal ends being closer to said first axis than said lower surface of said support members adjacent to said central member.

10. The hoist ring of claim 4 wherein said means to prevent said tether from sliding off said distal ends of said support members comprises:
a second axis running through both said first support member and said second support member, said second axis being substantially parallel to said first axis; and
said lower surface of said support members adjacent to said distal ends being closer to said first axis than said lower surface of said support members adjacent to said central member.

11. The hoist ring of claim 8 additionally comprising:
said first point being at said center point of said lower surface of one of said support members;
said second point being at said center point of said lower surface on the other of said support members; and
said third point being on said upper surface in between said first point and said second point.

12. The hoist ring of claim 1 additionally comprising:
said hoist ring adapted for engagement to said looped tether through a serpentine engagement of said looped tether around said pair of support members;
said looped tether being continuous from a first and second end; and
said first and second ends being continuously engaged to a lifting device, whereby said hoist ring is engageable to said tether without threading said tether through an eye or aperture.

13. The hoist ring of claim 10 additionally comprising:
said hoist ring adapted for engagement to said looped tether through a serpentine engagement of said looped tether around said pair of support members;
said looped tether being continuous from a first and second end; and
said first and second ends being continuously engaged to a lifting device whereby said hoist ring is engageable to said tether without threading said tether through an eye or aperture.

14. The hoist ring of claim 11 additionally comprising:
said hoist ring adapted for engagement to said looped tether through a serpentine engagement of said looped tether around said pair of support members;
said looped tether being continuous from a first and second end; and
said first and second ends being continuously engaged to a lifting device whereby said hoist ring is engageable to said tether without threading said tether through an eye or aperture.

15. The hoist ring of claim 3 additionally comprising:
said hoist ring adapted for engagement to said looped tether through a serpentine engagement of said looped tether around said pair of support members;
said looped tether being continuous from a first and second end; and
said first and second ends being continuously engaged to a lifting device whereby said hoist ring is engageable to said tether without threading said tether through an eye or aperture.

16. The hoist ring of claim 6 additionally comprising:
said first point being at said center point of said lower surface of one of said support members;
said second point being at said center point of said lower surface on the other of said support members; and
said third point being on said upper surface in between said first point and said second point.

17. The hoist ring of claim 1 additionally comprising:
said ring member, said central member, and said pair of support members being of unitary construction.
